(19) United States
(12) Patent Application Publication
(10) Pub. No.: US 2002/0138322 A1
(43) Pub. Date: Sep. 26, 2002

(54) Secure workflow system and method for the same

(76) Inventors: Katsuyuki Umezawa, Tokyo (JP); Tadashi Kaji, Waltham, MA (US)

Correspondence Address: MATTINGLY, STANGER & MALUR, PC, 104 EAST HUME AVENUE, ALEXANDRIA, VA, 22301, US

(21) Appl. No.: 09/814,822

(22) Filed: Mar. 23, 2001

(51) Int. Cl. G06F 17/60

(52) U.S. Cl. 705/8

(57) ABSTRACT

Subjects data indicating the names and positions of personnel and position hierarchy data indicating the hierarchical relations between positions are defined beforehand. When an activity status changes, activity status data is updated. When an activity is completed, history data is updated. Also, rules data is defined to indicate rules based on combinations of this data that specify personnel that cannot carry out activities (denied users), positions that cannot carry out activities (denied positions), personnel that must carry out activities (required users), and positions that must carry out activities (required positions). When a workflow server assigns personnel to activities, a security server is used to provide access control. The security server uses history data, activity status data, subjects data, position hierarchy data, and rules data to determine denied users, denied positions, required users, and required positions, and evaluates access permissions and determines assignment candidates.

### BACKGROUND OF THE INVENTION

The present invention relates to a security system for workflow systems used to carry out a plurality of linked activities. More specifically, the present invention relates to: an access control system based on hierarchical positions in the workflow system; an access control system based on history that takes into account the sequence of activities; and an access control system based on current status information that takes into account the status of other activities that are currently being carried out.

### SUMMARY OF THE INVENTION

Workflow refers to the flow of activities and defines who does what activities in what sequence. A workflow system is a system that carries out activities based on this kind of workflow. An example of this type of workflow system is described in page 18 through page 21 of “Workflow: Toward a Revolution in the Business Process” (authors: Yasuichi Ioda, Junichi Iijima, Haruo Hayamizu, and Masahiro Horiuchi; publisher: Nikkagiren Publishers). The following, with references to FIG. 14, is a summary of subject that should be improved in this publication.

Process definition data 423 defines contents of activities, starting and ending conditions, personnel carrying out activities, sequences of activities, and the like. Workflow control data 424 contains information used to control the workflow when the workflow is being executed. Activities data 425 contains information relating to results from activities and is not directly related to workflow control. An operations controller 422 interprets the process definition data 423 and manages the status of activities in the workflow. When an activity is started, a user assignment module 421 assigns a user to carry out the activity based on the personnel defined in the process definition data 423 to carry out the activity. When the personnel carrying out the activity finishes the activity, the operations controller 422 detects the completion of the activity, interprets the sequential relationship between activities in the process definition data 423, and advances workflow status information. However, in the method presented in this publication, the personnel carrying out activities are defined beforehand, and definitions cannot be made dynamically as workflow status advances.

As an example of an access control method for activities data, Japanese laid-open patent publication Hei 7-287688 describes a “method for dynamically changing access privileges and device for dynamically changing access privileges”. The operations involved in the method for dynamically changing access privileges and device for dynamically changing access privileges described in Japanese laid-open patent publication Hei 7-287688 provide dynamic changing of access privileges but the definitions used to make these changes are based on static definition information set up beforehand. Also, access control is provided for activity data and not for the activities themselves. In other words, there is no control provided over the actual carrying out of activities by personnel.

In workflow systems, setting up rules for personnel carrying out activities is important for security. There are cases where it would be desirable to provide fine degrees of control that respond to continuous changes in workflow activity status.

Furthermore, there are cases where it would be desirable to assign personnel by specifying, for example, positions in a company rather than directly specifying personnel to carry out activities.

Furthermore, there are cases where it would be desirable to require rather than deny personnel carry out activities.

Referring to FIG. 11, the following is a description of specific examples of these situations.

For example, there are cases where it would be desirable to set up a rule indicating that the personnel carrying out an activity 1 (201) must be an administrative worker.

Also, for example, when the activity 1 (201) is completed and the next activity 2 (202) is to be carried out, there are cases where it would be desirable to set up a rule indicating that the personnel carrying out the activity 2 (202) must be directly above the position of the personnel who carried out the activity 1 (202).

Also, for example, an activity 3 (203) and an activity 4 (204) are activities that are carried out at the same time in parallel to each other. There are cases where it would be desirable to set up a rule that indicates that the activity 3 (203) and the activity 4 (204) must not be carried out by the same personnel.

Also, for example, if there is a repetition (206), there are cases where it would be desirable to set up a rule that indicates that the personnel carrying out the second and subsequent iterations of the activity 1 (201) must be the same personnel who carried out the first activity 1 (201).

The present invention was developed in light of these issues. The object of the present invention is to provide a method for performing access control not only on activity data but also on the assigning of personnel to activities as well as performing access control based on information that changes dynamically with transitions in the workflow and a device implementing this method.

In order to solve the problems described above, a workflow system according to the present invention includes: at least one workflow server that defines a plurality of activities, flows of the plurality of activities, and personnel for the plurality of activities, that controls status information of the plurality of activities, that assigns personnel to the plurality of activities, and that manages the flows of the plurality of activities; at least one security server providing access control in the assigning of personnel to activities in response to requests from the workflow server; at least one workflow client on which the personnel assigned to activities by the workflow server actually carries out the activities; and workflow-related data used in operations performed by the workflow client, the workflow server, and the security server.

The workflow-related data includes: history data storing past activity status information; work status data storing current activity status information; subjects data storing positions of personnel; position hierarchy data storing personnel position hierarchy; and rules data storing rules for assigning personnel.

The workflow server includes: an operations controller controlling the status of the plurality of activities based on pre-defined process definition data defining activity contents, start and end conditions for activities, activity sequences, and the like; and a user assigning module assigning users to activities based on pre-defined personnel carrying out activities.

The security server includes: a rules retrieval module retrieving rules from the rules data; a rules evaluating module making evaluations using rules retrieved by the rules retrieval module and based on history data, activity status data, subjects data, and position hierarchy data; an access permission evaluating module determining whether specified personnel can carry out specified activities based on evaluations obtained from rules evaluating means; and an assignment candidates retrieval module retrieving assignable personnel candidates based on evaluations obtained from rules evaluating means.

In the secure workflow system of the present invention, subjects data indicating personnel names and positions and position hierarchy data indicating hierarchical relations between positions are defined beforehand.

When activity status changes, activity status data is updated.

When an activity is completed, history data is updated.

Rules data are defined to indicate rules used to specify personnel that cannot carry out activities, positions that cannot carry out activities, personnel that must carry out activities, and positions that must carry out activities based on combinations of history data, activity status data, subjects data, and position hierarchy data.

When the workflow server assigns activity personnel, it uses the security server to evaluate access permissions and to retrieve candidate personnel who can be assigned. The security server uses the combination of history data, activity status data, subjects data, and position hierarchy data to determine personnel that can carry out activities, positions that can carry out activities, personnel that must carry out activities, and positions that must carry out activities. This is used to evaluate access permissions for specified personnel and to retrieve assignable personnel candidates.

Thus, with the present invention, dynamic access control can be provided for assigning personnel to activities based on history data and work status data, which change with transitions in the workflow.

Also, since position data that does not directly specify personnel is used, access control based on positions of personnel can be provided.

Also, flexible access control can be provided since rules can indicate personnel who must carry out activities in addition to indicating personnel who are prohibited from carrying out activities.

### BRIEF DESCRIPTION OF THE DRAWINGS

FIG. 1 is a drawing for the purpose of describing the system architecture of a secure workflow system implementing an embodiment of the present invention.

FIG. 2 is a drawing for the purpose of describing a network architecture of a secure workflow system-implementing an embodiment of the present invention.

FIG. 3 is a drawing indicating a sample structure for the rules table shown in FIG. 1.

FIG. 4 is a drawing indicating a sample structure for the subjects table shown in FIG. 1.

FIG. 5 is a drawing indicating a sample structure for the position hierarchy table shown in FIG. 1.

FIG. 6 is a drawing indicating a sample structure for the history table shown in FIG. 1.

FIG. 7 is a drawing indicating a sample structure for the activity status table shown in FIG. 1.

FIG. 8 is a flowchart for the purpose of describing the operations performed by an access control evaluating module in a secure workflow system implementing an embodiment of the present invention.

FIG. 9 is a flowchart for the purpose of describing the operations performed by a rules evaluating module in a secure workflow system implementing an embodiment of the present invention.

FIG. 10 is a flowchart for the purpose of describing the operations performed by a rules retrieval module in a secure workflow system implementing an embodiment of the present invention.

FIG. 11 is a workflow diagram for the purpose of describing the types of rules in a secure workflow system implementing an embodiment of the present invention.

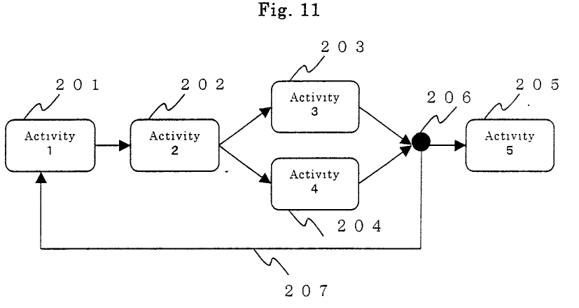

FIG. 12 is a drawing showing an example of a rule in a secure workflow system implementing an embodiment of the present invention.

FIG. 13 is a drawing showing an example of a rule in a secure workflow system implementing an embodiment of the present invention.

FIG. 14 is a drawing for the purpose of describing how a conventional workflow system works.

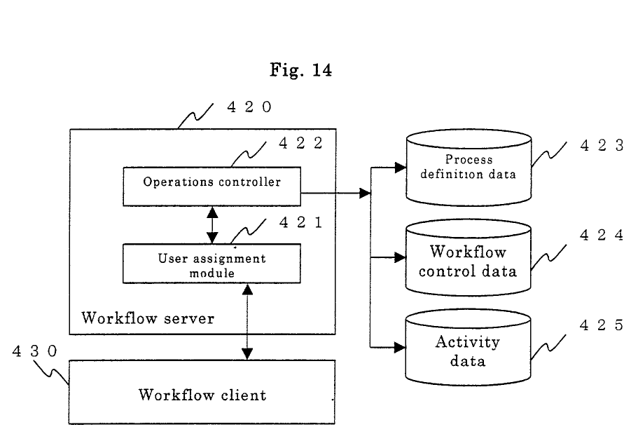

FIG. 15 is a flowchart for the purpose of describing the operations performed by an assignment candidates retrieval module in a secure workflow system implementing an embodiment of the present invention.

FIG. 16 is a flowchart for the purpose of providing a detailed description of step 142 in FIG. 15, where a denied users group is determined.

FIG. 17 is a flowchart for the purpose of providing a detailed description of step 143 in FIG. 15, where a required users group is determined.

### DETAILED DESCRIPTION OF THE DRAWINGS

The following is a description of an embodiment of the present invention, with references to the drawings. However, present invention is not restricted to this embodiment.

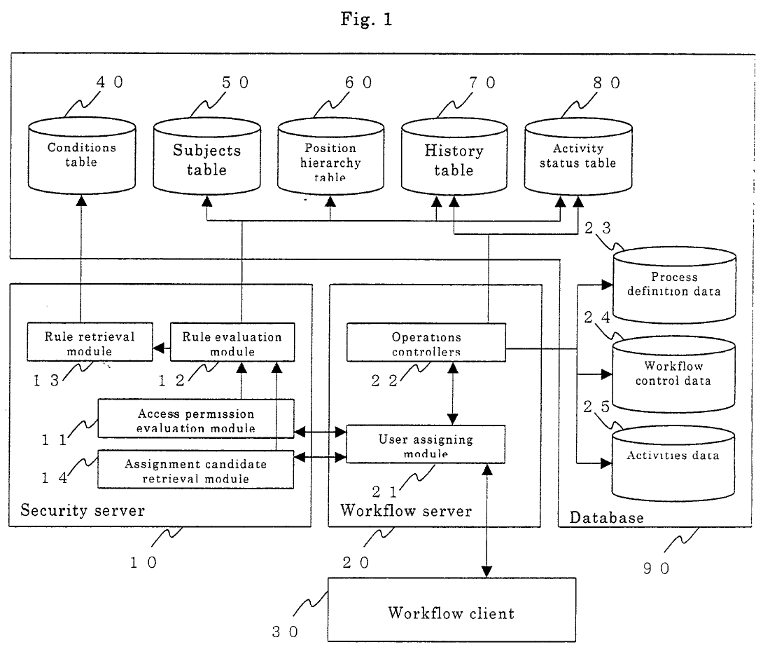

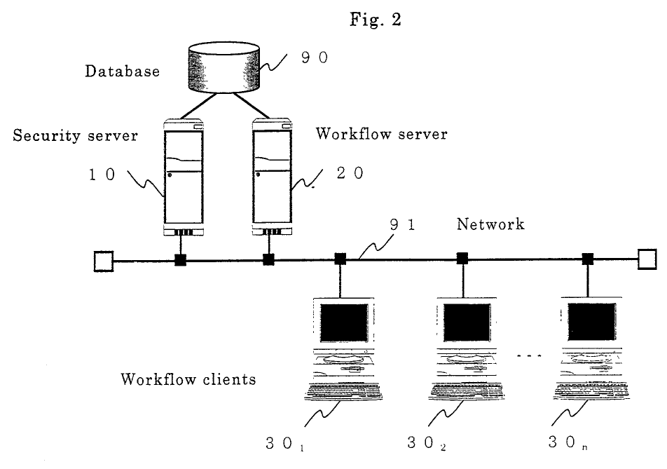

FIG. 1 is a drawing showing the architecture of a secure workflow system in which an embodiment of the present invention is implemented. FIG. 2 is a drawing showing the network architecture of a secure workflow system in which an embodiment of the present invention is implemented.

In the secure workflow system of this embodiment as shown in FIG. 2, workflow clients 301-30n (also referred to hereinafter as simply workflow clients 30), a workflow server 20, and a security server 10 are connected to each other through a communication network 91 such as a LAN. Also, a database 90 is connected to the workflow server 20 and the security server 10.

The database 90 manages data relating to security and data relating to workflow. As shown in FIG. 1, the database 90 includes: a history table 70 storing past activity status information; an activity status table 80 storing current activity status; a subjects table 50 storing the positions of personnel; a position hierarchy table 60 storing the hierarchy of personnel positions; a conditions table 40 storing conditions, which are rules assigned for personnel; process definition data 23 defining contents of activities, starting and ending conditions, personnel to carry out activities, sequences of activity, and the like; workflow control data 24, which is information for controlling a workflow during execution of the workflow; and activity data 25, which is information, not directly related to workflow control, about the results provided by the activity.

The workflow server 20 does the following: defines a plurality of activities, the flow of the plurality of activities, the personnel handling the plurality of activities; controls the status for the plurality of activities; assigns personnel to the plurality of the activities; and manages the flow of the plurality of activities. As shown in FIG. 1, an operations controller 22 controls status information for the plurality of activities based on process definition data 23, workflow control data 24, and activities data 25. A user assigning module 21 assigns candidates for personnel to handle activities based on workflow control data 24 and activities data 25. Also, the user assigning module 21 queries the security server 10 to determine if these candidates are permitted access or not. Based on these results, personnel to whom access is granted are assigned to activities. Also, the user assigning module 21 assigns personnel candidate groups to handle activities based on workflow control data 24 and activities data 25. The user assigning module 21 queries the security server 10 to determine if these candidates groups are permitted access or not. Based on these results, personnel candidate groups to whom access is granted are assigned to activities.

In response to queries from the workflow server 20, the security server 10 provides access control over the assignment of personnel to activities. A rules retrieval module 13 retrieves rules from the rules table 40. Based on information stored in the history table 70, the activities status table 80, the subjects table 50, and the position hierarchy table 60, a rules evaluation module 12 determines if candidates fulfill the rules retrieved by the rules retrieval module 13. An assignment candidates retrieval module 14 uses the evaluation obtained from the rules retrieval module 13 and the rules evaluation module 12 to determine a group of personnel that can perform the specified activity.

The personnel assigned to activities by the workflow server 20 perform their activities on the workflow clients 30.

The following is a description of the data formats relating to security used in the secure workflow system according to this embodiment.

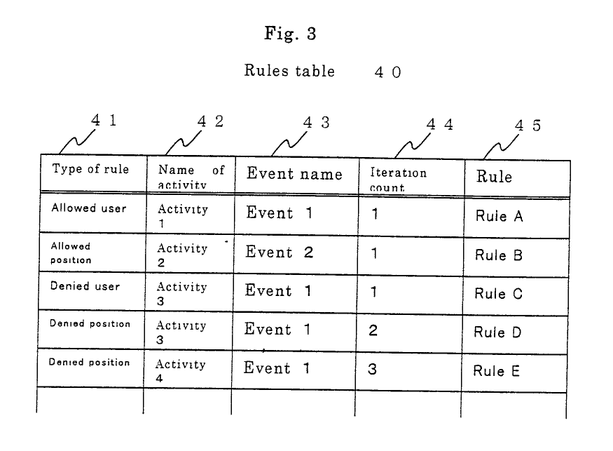

FIG. 3 shows a rules table storing personnel assignment rules. A rule type 41 indicates whether a rule is for defining denied users, for defining denied positions, for defining required users, or for defining required positions. An activity name 42 indicates activity names to which the rules are applied. An event name 43 indicates event names to which the rules are applied. An iteration count 44 indicates the number of iterations that are to be performed for the activity associated with a rule. A rule 45 indicates rules used to determine the users or the positions of the type specified by the rule type 41.

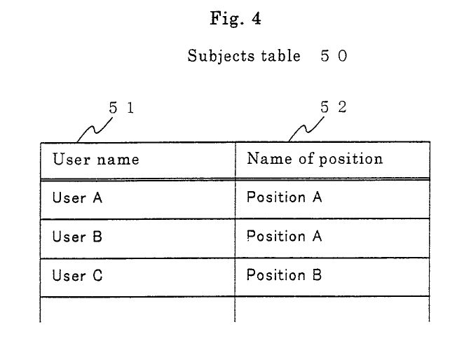

FIG. 4 shows the subjects table storing the positions of personnel. A user name indicates the names of personnel handling activities. A position name 52 indicates positions of personnel handling activities.

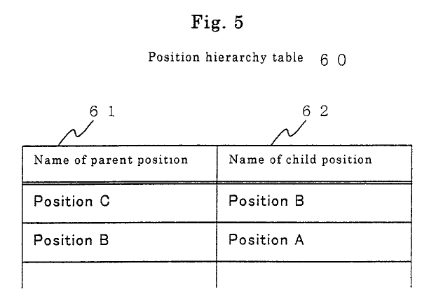

FIG. 5 shows the position hierarchy table storing the position hierarchy of personnel. A parent position name 61 indicates hierarchically higher positions. Conversely, a child position name 62 indicates hierarchically lower positions.

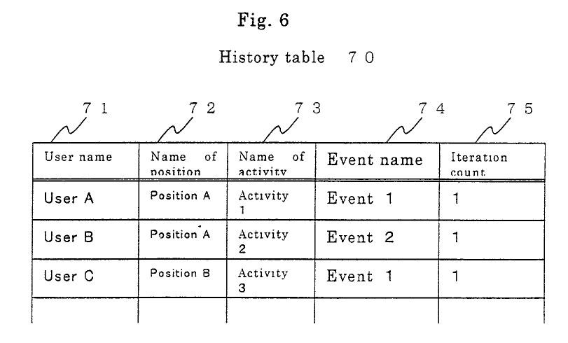

FIG. 6 shows a history table storing past activity status information. A user name 71 indicates names of personnel that carried out activities. A position name 72 indicates the positions of personnel that carried out activities. An activity name 73 indicates activity names of activities carried out by personnel. An event name 74 indicates event names of activities carried out by personnel. An iteration count 75 indicates the number of times the activity carried out by personnel was performed.

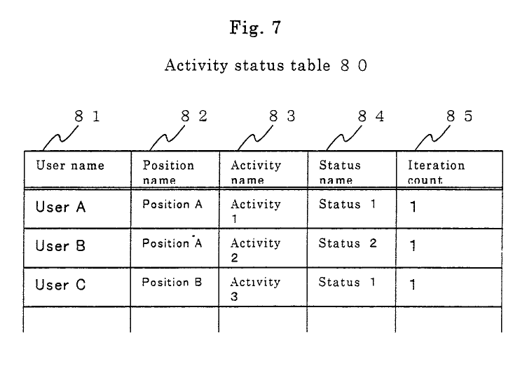

FIG. 7 shows an activity status table storing current activity status. A user name 81 indicates the name of personnel carrying out current activities. A position name 82 indicates positions of personnel carrying out current activities. An activity name 83 indicates activity names of activities currently being carried out by personnel. A status name 84 indicates status names of activities currently being carried out by personnel. An iteration count 85 indicates the number of iterations to be carried out for activities currently being performed by personnel.

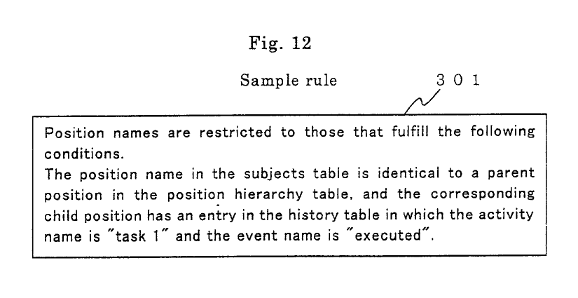

FIG. 12 is an example of a rule set up in the rule 45 of the rules table 40. This rule is used to select appropriate personnel or positions based on history data storing past activity states, activity status data storing current activity states, and subjects data storing personnel positions, and position hierarchy data storing position hierarchies of personnel.

The following is a description of the flow of operations performed by the security server of the secure workflow system of this embodiment in order to evaluate access permissions and retrieve assignment candidates.

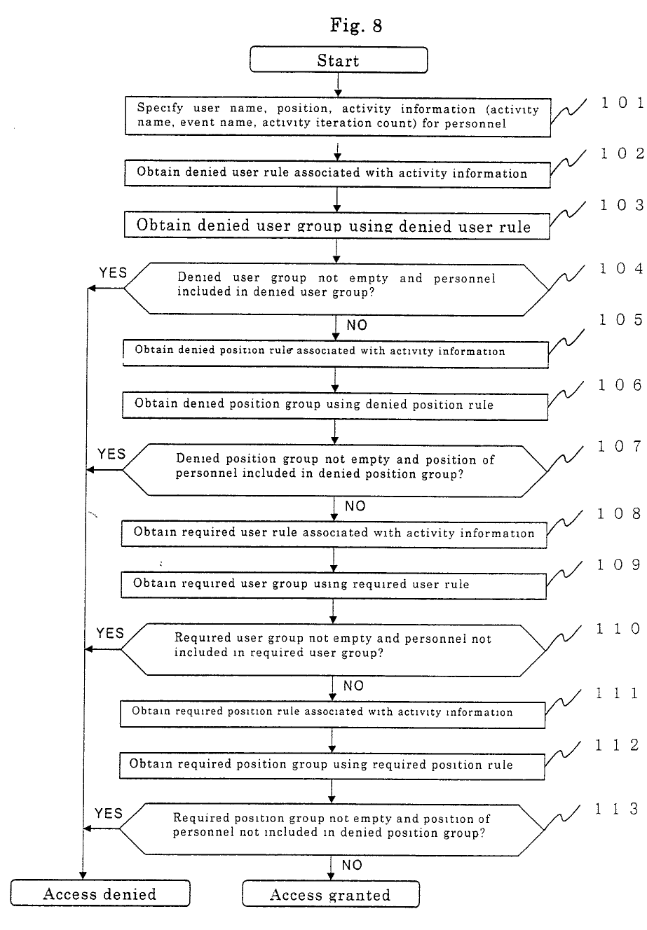

FIG. 8 is a flowchart showing the flow of operations performed when the access permission evaluation module 11 evaluates access permissions. First, the workflow server specifies the user name, the position, and activity information (activity name, event name, and activity iteration count) for the personnel on which access permission evaluation is to be performed (step 101).

Next, a denied user rule associated with the activity information (activity name, event name, activity iteration count) is obtained (step 102). Based on the obtained denied user rule, a group of denied users is obtained (step 103). Next, the denied user group is checked to see if it is empty and the group is checked to see if it includes the personnel specified in step 101 (step 104). If the denied user group is not empty and the personnel specified in step 101 is included in the denied user group, access is denied and the evaluation is completed. If the denied user group is empty or the personnel specified in step 101 is not included in the denied user group, control proceeds to the next step.

Next, a denied position rule associated with the activity information (activity name, event name, activity iteration count) is obtained (step 105). Based on the obtained denied position rule, a group of denied positions is obtained (step 106). Next, the denied position group is checked to see if it is empty and the group is checked to see if it includes the position of the personnel specified in step 101 (step t07). If the denied position group is not empty and the position of the personnel specified in step 101 is included in the denied position group, access is denied and the evaluation is completed. If the denied position group is empty or the position of the personnel specified in step 101 is not included in the denied position group, control proceeds to the next step.

Next, a required user rule associated with the activity information (activity name, event name, activity iteration count) is obtained (step 108). Based on the obtained required user rule, a group of required users is obtained (step 109). Next, the required user group is checked to see if it is empty and the group is checked to see if it includes the personnel specified in step 101 (step 110). If the required user group is not empty and the personnel specified in step 101 is not included in the required user group, access is denied and the evaluation is completed. If the required user group is empty or the personnel specified in step 101 is included in the required user group, control proceeds to the next step.

Next, a required position rule associated with the activity information (activity name, event name, activity iteration count) is obtained (step 111). Based on the obtained required position rule, a group of required positions is obtained (step 112). Next, the required position group is checked to see if it is empty and the group is checked to see if it includes the position of the personnel specified in step 101 (step 113). If the required position group is not empty and the position of the personnel specified in step 101 is not included in the required position group, access is denied and the evaluation is completed. If the required position group is empty or the position of the personnel specified in step 101 is included in the required position group, access is allowed and the evaluation is completed.

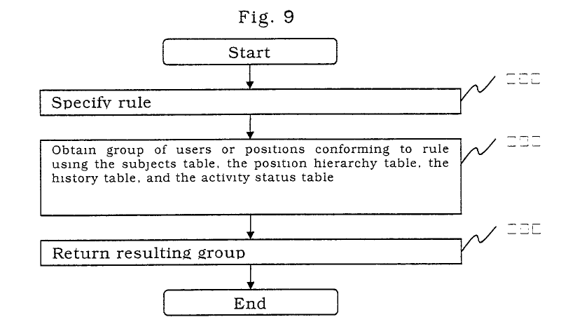

FIG. 9 is a flowchart showing the flow of operations performed by the rule evaluation module 12 to evaluate rules.

First a rule obtained from step 102, step 105, step 108, or step 111, from the flowchart in FIG. 8 showing the flow of operations performed to evaluate access permissions, is specified (step 131). The only differences in these steps is the rule type. Next, a group of personnel or positions conforming to the rule is obtained using the subjects table, the position hierarchy table, the history table, and the activity status table (step 132). Finally, the resulting group of personnel or positions is returned to the caller (step 133).

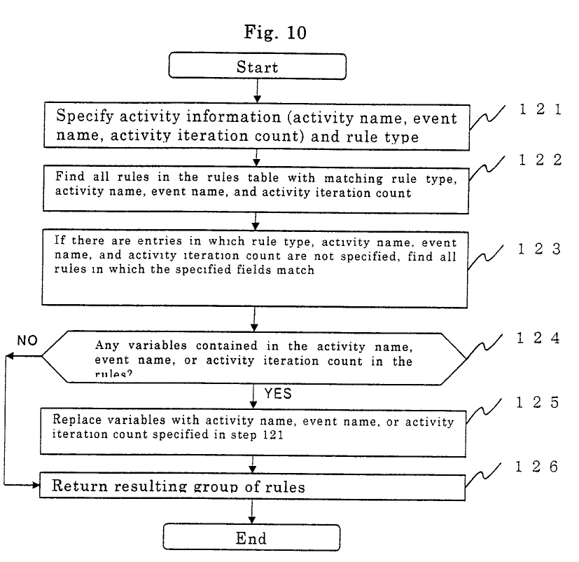

FIG. 10 is a flowchart showing the flow of operations performed by the rule retrieval module 13 to retrieve rules.

First, activity information (activity name, event name, activity iteration count) and a rule type are specified (step 121). Next, all rules in the rules table matching the rule type, activity name, event name, and activity iteration count are retrieved (step 122). Next, if the rules table contains rules that do not specify the activity name, event name, or activity iteration count, the rules matching the specified fields are retrieved (step 123). Next, rules are checked to see if they contain variables in the activity name, event name, or activity iteration count (step 124). If there are variables, these variables are replaced with the activity name, event name, or activity iteration count specified in step 121. Finally, the resulting group of rules is returned to the caller (step 126). If, at step 124, there were no variables, step 126 is executed.

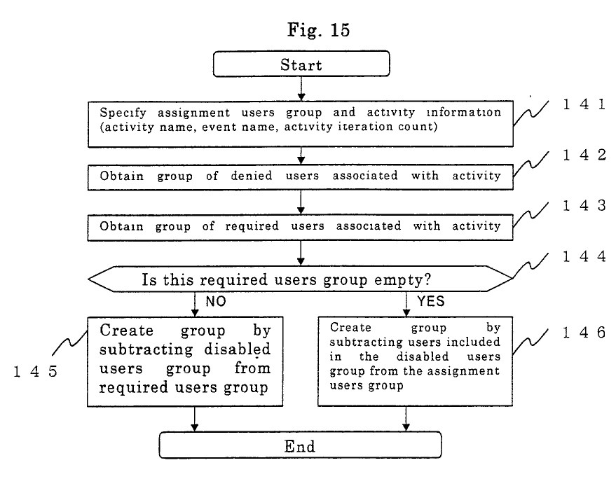

FIG. 15 is a flowchart showing the flow of operations performed by the assignment candidates retrieval module 14 to retrieve assignment candidates. First, the workflow server specifies a user group on which assignment is based, as well as activity information (activity name, event name, activity iteration count) (step 141).

Next, a denied users group associated with the activity information (activity name, event name, and activity iteration count) is retrieved (step 142). Next, a required users group associated with the activity information (activity name, event name, and activity iteration count) is retrieved (step 143). If the required users group determined at step 143 is not empty, a group in which the denied users group is excluded from the required users group is determined (step 145). If the required users group determined at step 143 is empty, a group in which the denied users group is excluded from the users group on which assignment is based, specified in step 141, is determined (step 146).

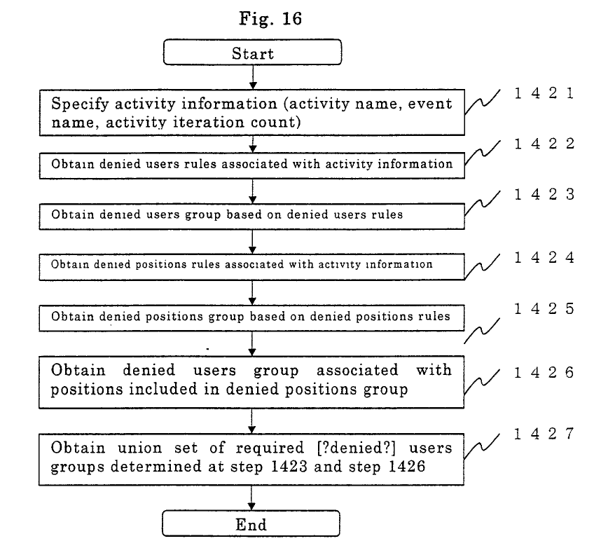

FIG. 16 is a flowchart for the purpose of providing a detailed description of the operations used in step 142 from FIG. 15 to obtain a denied users group associated with activity information.

First, activity information (activity name, event name, activity iteration count) is specified (step 1421). Next, a denied users rule associated with the activity information is retrieved (step 1422). Using the retrieved denied users rule, a group of denied users is obtained (step 1423). Next, a denied position rule associated with the activity information is retrieved (step 1424). Using the retrieved denied positions rule, a group of denied positions is retrieved (step 1425). Next, a denied users group associated with the positions included in the denied positions group is retrieved. Finally, a group containing elements included in either the denied users group obtained at step 1422 or the denied users group obtained in step 1426 is determined (a union set).

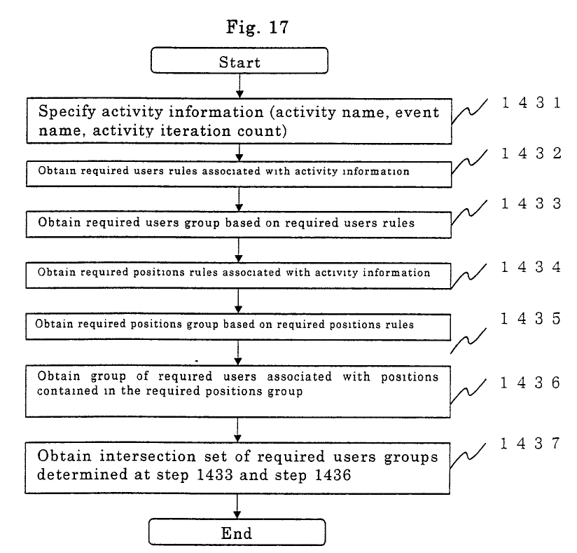

FIG. 17 is a flowchart for the purpose of providing a detailed description of the operations performed in step 143 from FIG. 15 to obtain a group of required users associated with activity information.

First, activity information (activity name, event name, activity iteration count) is specified (step 1431). Next, a required user rule associated with the activity information is retrieved (step 1432). The retrieved required user rule is used to obtain a required users group (step 1433).

Next, a required position rule associated with the activity information is retrieved (step 1434). The retrieved required position rule is used to obtain a required positions group (step 1435). Next, a required users group associated with the positions contained in the required positions group is obtained. Finally, a group containing elements included in both the required users group obtained at step 1432 and the required users group obtained in step 1436 is determined (an intersection set)

The present invention is not restricted to the embodiment described above, and various modifications may be made.

For example, the subjects table in this embodiment contains only personnel names and position names, but it would also be possible to include various other attributes of personnel (e. g., identification names and group names).

Also, the position hierarchy information in this embodiment uses a table format containing only parent positions and child positions, but it would also be possible, for example, to represent and manage various hierarchical structures in an organization in a tree structure.

Also, the history table in this embodiment contains personnel names, position names, activity names, event names, and iteration counts. However, it would also be possible to store other information such as the time at which the activity was finished.

Also, the activity status table of this embodiment contains personnel names, position names, activity names, status names, and iteration counts. However, it would also be possible to store other information such as the time at which an activity was begun.

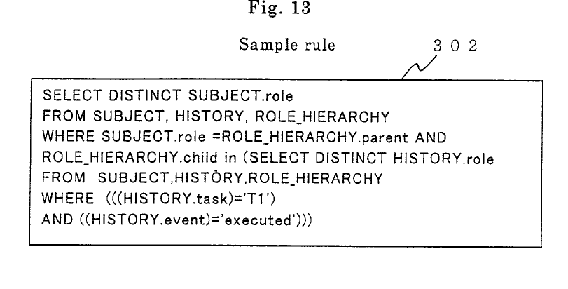

Also, rules in this embodiment are written in a natural language format using English. However, it would also be possible to use a database querying language such as shown in FIG. 13 or some other language.

Also, in this embodiment the workflow server and the security server are implemented as separate devices but it would also be possible to implement these in the same device.

In the present invention as described above, dynamic access control that varies according to transitions in the workflow can be provided using history data, activity status data, and activity iteration counts. Also, since position data not directly specifying personnel is used, access control based on personnel positions can be provided. Also, requirement rules can be specified in addition to denial rules, thus allowing flexible access control.

We claims,

1. An access control method in a workflow system that defines a plurality of activities, a flow of said plurality of activities, and personnel for said plurality of activities, assigns personnel to said plurality of activities, and manages said flow of said plurality of activities,
wherein said access control method assigning personnel to activities by evaluating access permissions based on at least two of past activity status, current activity status, and activity iteration counts.

2. An access control method as described in claim 1 wherein access permission is evaluated based on at least two of past activity status, current activity status, and activity iteration counts, and at least one of positions of personnel and hierarchies of said positions.

3. An access control method as described in claim 1 wherein access permission is evaluated based on personnel that cannot carry out activities, positions that cannot carry out activities, personnel that must carry out activities, and positions that must carry out activities based on at least two of past activity status, current activity status, activity iteration counts, positions of personnel, and hierarchies of said positions.

4. A secure workflow system defining a plurality of activities, a flow of said plurality of activities, personnel for said plurality of activities, controlling said plurality of activities, assigning personnel to said plurality of activities, and managing said flow of said plurality of activities, comprising an access control unit used in assigning personnel to activities;
said access control unit comprising:
a 1st memory storing past activity status information;
a 2nd memory storing current activity status information;
a 3rd memory storing rules for assigning personnel;
a processor evaluating access permissions of personnel to activities based on an information stored in said 1st memory, 2nd memory and 3rd memory.

5. A secure workflow system as described in claim 4 further comprising:
a 4th memory storing personnel positions;
a 5th memory storing personnel position hierarchy; and
said processor evaluating access permissions of personnel to activities based on an information stored in said 1st memory, 2nd memory, 3rd memory, 4th memory and 5th memory.

6. A workflow management system comprising:
1st unit which defines a plurality of tasks;
2nd unite which defines a flow of said plurality of tasks;
3rd unit which defines personnels for said plurality of tasks;
4th unit which assignes selected personnel to said plurality of tasks;
5th unit generates assignment candidates capable of being assigned for specific task based on at least one of past activity status, current activity status, and activity iteration counts.

7. A workflow management system described in claim 6,
said 5th unit generates assignment candidates capable of being assigned for specific task based on at least one of past activity status, current activity status, activity iteration counts, personnel positions, and position hierarchy.

8. A workflow management system described in claim 7,
said 5th unit generates candidate personnel capable of being assigned based on personnel that cannot carry out activities, positions that cannot carry out activities, personnel that must carry out activities, and positions that must carry out activities based on at least one of past activity status, current activity status, activity iteration counts, personnel positions, and position hierarchy.

9. A workflow system defining a plurality of activities, a flow of said plurality of activities, and personnel for said plurality of activities, controlling said plurality of activities, assigning personnel to said plurality of activities, and managing said flow of said plurality of activities, comprising:
a device for generating assignment candidates assigning personnel to activities comprising:
means for storing history storing past activity status information;
means for storing status storing current activity status information;
means for storing rules storing rules for assigning personnel;
means for retrieving rules retrieving rules from said rules storing means;
means for evaluating rules determining items conforming to a rule obtained from said rule retrieving means based on a combination of information stored in said history storing means and said status storing means; and
means for generating assignment candidates determining personnel candidates capable of being assigned based on an evaluation obtained from said rules evaluating means.

10. A secure workflow system as described in claim 9 further comprising:
means for storing first information storing first information about personnel;
means for storing second information storing second information about personnel; and
said rules evaluating means determining items conforming to a rule obtained from said rule retrieving means based on a combination of information stored in said history storing means, said status storing means, said first information storing means, and said second information storing means.
